(19) United States
(12) Patent Application Publication
(10) Pub. No.: US 2009/0157797 A1
(43) Pub. Date: Jun. 18, 2009

(54) DATA DISTRIBUTION SYSTEM

(75) Inventors: Sophie Chang, London (GB); Michael Saxton, Fetcham (GB); Mark Blackburn, Maidenhead (GB)

Correspondence Address: SCHWEGMAN, LUNDBERG & WOESSNER, P.A., P.O. BOX 2938, MINNEAPOLIS, MN, 55402, US

(73) Assignee: 1E Limited, a British company of CP House, London (GB)

(21) Appl. No.: 12/266,294

(22) Filed: Nov. 6, 2008

(30) Foreign Application Priority Data
Nov. 7, 2007 (GB) 07218613

(51) Int. Cl. G06F 15/16

(52) U.S. Cl. 709/202; 709/219

(57) ABSTRACT

A data processing system for distributing a package of data from a source to a plurality of data processing machines arranged in a plurality of sites. The data is transmitted from the source to the plurality of data processing machines by means of a multicast. At each site, a local data processing machine is designated as a site master; the other local data processing machines report missing data portions to the site master; and the site master consolidates reports of missing data portions, and requests missing data portions from the source. The source then transmits the missing data portions to the plurality of data processing machines by means of a further multicast. If the site master receives a report of missing data that the site master has stored locally, the site master provides that missing data to the local machines by means of a site multicast. Reports of missing data received by the source from site masters at different sites are consolidated at the source before the source transmits the missing data to the plurality of sites by means of the further multicast. If a local machine is missing data from the multicast from the source, and is not aware that a site master has been designated, that local machine broadcasts to machines at that site information indicating that a site master is required. If a site master is already designated, that site master notifies that local machine that it is the site master; but if no site master is already designated, an election process is instigated to designate one of the machines at that site as site master.

### RELATED APPLICATION

This application claims priority under 35 U.S.C. 119 to United Kingdom Application No. 0721861.3, filed Nov. 7, 2007, which application is incorporated herein by reference and made a part hereof.

### FIELD OF THE INVENTION

The present invention relates to a data distribution system. The invention is particularly, but not exclusively, concerned with improving the distribution of data such as software packages to and/or within branch offices.

### BACKGROUND TO THE INVENTION

Where an organisation has one or more branch offices each with a number of workstations such as PC's, one way of distributing a data package such as a software update from a central location, is to download the package to a server at the branch, which will then be used to distribute the package to the local workstations. However, many organisations prefer to avoid the use of servers in branch offices as they involve additional hardware, software, implementation and maintenance costs. There are products available from 1E Limited, based in London England, known as Nomad Branch™ and Nomad Branch Multicast™, which address the problem of distributing data to a branch without the use of a server at the branch. The data is transmitted to one of the workstations at the branch, which acts as a master for distributing the data to the other workstations at the branch. There is a process for electing which workstation should act as the master. If there is a small number of workstations, it is possible to store the downloaded data on a share from which other workstations receive their copy of the data. For larger numbers of workstations in a branch, it is preferred that the local master uses multicast to distribute the data to the other workstations. Information concerning the Nomad Branch™ and Nomad Branch Multicast™ products is available from 1E Ltd at CP House, 97-107 Uxbridge Road, London W5 5TL, England. Proposals concerning such systems are discussed in U.S. patent application Ser. No. 11/035,022 of Chang et al, which is incorporated herein in its entirety by way of reference.

In a multicasting operation, data is duplicated at each router and sent on to each receiver, whereas in a unicast arrangement the data is duplicated at source and routed to the various receivers. Multicasting frequently uses UDP (User Datagram Protocol) which does not provide the reliability and ordering guarantees that, for example, TCP (Transmission Control Protocol) does. Datagrams may arrive out of order or go missing without notice. Without the overhead of checking if every packet actually arrived, UDP is faster and more efficient for some purposes such as streaming audio or video, where packet loss is acceptable. However, for the delivery of a software update package, for example, it is imperative that all data arrives at each workstation and there is no corruption.

In the arrangement disclosed in U.S. application Ser. No. 11/035,022, a distribution site is provided with a Microsoft™ SMS™ (Systems Management Server) which downloads an update package over a WAN (Wide Area Network) to a workstation in a branch elected as a download master. That unicast download is reliable and, for example, uses CRC (Cyclic Redundancy Checking) to ensure that all packets of data are safely received. Multicast technology can then be used within the branch to distribute the package to other workstations, and there are systems disclosed for dealing with missing data.

Such arrangements are advantageous in the context of providing efficient deployment of data within branches, but in many cases there are organisations with large numbers of branches and it is desirable for there to be a system for improving the efficiency of deployment of data both to the branches and within branches.

### SUMMARY OF THE INVENTION

Viewed from one aspect, the invention provides A data processing system comprising a central data processing data source and a plurality of remote data processing machines arranged in a plurality of sites, there being a plurality of said data processing machines at each said site, wherein: the central data processing data source is configured to transmit data from the source to the plurality of remote data processing machines by multicasting; at each said site: one of the plurality of data processing machines at the site is configured to be designated as a site master; the remainder of the plurality of data processing machines at the site are configured to report missing data portions to the site master; and the site master is configured to consolidate reports of missing data portions, and to request missing data portions from the central data processing source; and wherein the central data processing source is configured to process requests for missing data portions from the site master at each said site, and to multicast the missing data portions to the plurality of remote data processing machines.

In one arrangement the data processing machines at a site could receive all data directly by means of a global multicast from the source. In an alternative arrangement, at least some of the data received by data processing machines at a site is received by means of a local multicast from the site master, which has itself received the data by means of a global multicast from the source. In some embodiments, however, the local machines principally receive the data directly by means of a global multicast from the source, but report missing data to the site master, rather than directly to the source. If the site master has the missing data stored locally, it will then provide that missing data to the local machines by means of a site multicast. However, if the site master does not have the missing data stored locally, a consolidated request for missing data will be made to the source by the site master. The source will then include the missing data in a global multicast to all machines at all sites.

In one arrangement, requests for missing data from different site masters are consolidated so that a single multicast of missing data portions can satisfy the needs of the multiple sites. Conceivably, if there is a small number of sites, this could be done by site masters communicating with each other and electing a grand master which consolidates the requests from the various sites and transmits a consolidated request to the source. In another implementation of the invention, however, the source itself collates multiple requests for missing data from multiple sites, and transmits a single multicast of missing data portions which can satisfy the needs of the multiple sites.

Embodiments of the present invention provide the advantage that distributing packages to multiple sites can be handled by multicasting, with all sites receiving the same multicast stream. This is particularly advantageous if the aggregate bandwidth that would be utilised by separate unicast streams to the sites would exceed the network capacity at points in the network. On the other hand, requests to the originating point of the multicast for missing data are limited so as to come from a site master at each site, thus restricting the traffic over the WAN. The missing data is then multicast to all machines across all sites. The end result is that each machine at each site will have a complete, accurate copy of the package, whilst network traffic over the WAN is reduced. The advantages of multicasting are retained, even though it is essential that all packets are received, since requests for missing packets are handled by the site master rather than being passed back to the originating point from each individual machine.

Viewed from another aspect, the invention provides a data processing system comprising a plurality of data processing machines at a site, wherein at said site: the data processing machines are each configured to receive data as a multicast from a central source remote from the site; one of the data processing machines is designated as a site master; the remaining data processing machines are configured to report missing data portions to the site master; and the site master is configured to consolidate reports of missing data portions, and to request missing data portions from the central source; and wherein the data processing machines are configured to receive missing data portions in a further mulficast from the central source.

Optionally, at said site the data processing machines are configured such that each machine can act both: (i) as said site master which receives reports of missing data portions from the remainder of the plurality of data processing machines at the site, consolidates the reports of missing data portions, and requests missing data portions from the central data processing source; or (ii) as one of the remainder of the plurality of data processing machines which reports missing data portions to the site master.

Viewed from another aspect, the invention provides a data processing machine at site where there is a plurality of data processing machines, wherein said data processing machine is configured to adopt a first operational state and a second operational state, and to choose between the first and second operational states, wherein: (i) in the first operational state said data processing machine is configured to receive data as a multicast from a central source remote from the site; to report missing data portions to another data processing machine at the site designated as a site master; and to receive missing data portions in a further multicast; and (ii) in the second operational state the first data processing machine is configured to act as a site master which: (a) receives data as a multicast from a central source remote from the site; and (b) receives reports of missing data portions from the remainder of the plurality of data processing machines at the site, consolidates the reports of missing data portions, and requests missing data portions from the central source.

When the data processing machine is in the first operational state it may be configured to receive missing data portions in a further multicast from the central source and from the site master. When the data processing machine is in the second operational state it may be configured: (i) to store in a cache the data in the multicast from the central source; (ii) in response to a report of a missing data portion from another of the data processing machines at the site, to identify whether the missing data portion is in the cache; (iii) if the missing data portion is in the cache, to transmit the missing data portion in the cache to other data processing machines at the site by a local multicast; and (iv) if the missing data portion is not in the cache, to request the missing data portions from the central source.

Viewed from another aspect, the invention provides a computer readable medium having computer executable instructions adapted to cause a data processing machine to be configured so that: said data processing machine can adopt a first operational state and a second operational state, and can elect between the first and second operational states, wherein: (i) in the first operational state said data processing machine is configured to receive data as a multicast from a central source remote from the site; to report missing data portions to another data processing machine at the site designated as a site master; and to receive missing data portions in a further multicast; and (ii) in the second operational state the first data processing machine is configured to act as a site master which: (a) receives data as a multicast from a central source remote from the site; and (b) receives reports of missing data portions from the remainder of the plurality of data processing machines at the site, consolidates the reports of missing data portions, and requests missing data portions from the central source.

Viewed from another aspect, the invention provides a central server configured for distributing data to a plurality of remote data processing machines arranged in a plurality of sites, there being a plurality of said data processing machines at each said site, wherein the server is configured: (i) to transmit the data as a global multicast to the data processing machines; (ii) to receive from a master data processing machine at each remote site, a notification of missing data portions reported to the master data processing machine by other of the other machines at the site; (iii) to consolidate reports of missing data portion received by the source from site masters at different remote sites; and subsequently (iv) to transmit the missing data to the plurality of remote data processing machines by means of a further global multicast.

The invention extends not just to the overall system, but to an overall method, to a method carried out at the site, to a method carried out on a machine at the site, to a method carried out at central multicast data processing server, to a software product for configuring a machine at a site to carry out the method, and to a software product for configuring a central multicast data processing server to carry out the method.

Thus, viewed from another aspect, the present invention provides a method of distributing data from a source to a plurality of data processing machines arranged in a plurality of sites, wherein: the data is transmitted from the source to the plurality of data processing machines by multicasting; at each site: a data processing machine is designated as a site master; the data processing machines report missing data portions to the site master; and the site master consolidates reports of missing data portions, and requests missing data portions from the source; and wherein the source multicasts the missing data portions to the plurality of data processing machines. Viewed from another aspect, the invention provides a computer readable medium having computer executable instructions adapted to cause a data processing machine to perform the above method.

Viewed from another aspect, the invention provides a method of distributing data from a source to a plurality of data processing machines at a site, wherein: the data is received by the data processing machines as a multicast from a central source remote from the site; one of the data processing machines is designated as a site master; the remaining data processing machines report missing data portions to the site master; and the site master consolidates reports of missing data portions, and requests missing data portions from the central source; and wherein the data processing machines receive missing data portions in a further multicast from the central source, and/or from cached data on the site master. Viewed from another aspect, the invention provides a computer readable medium having computer executable instructions adapted to cause a data processing machine to perform the above method.

Viewed from another aspect, the invention provides a method carried out by a first data processing machine at site where there is a plurality of data processing machines, wherein: data is received by the first data processing machine as a multicast from a central source remote from the site; the first data processing machine reports missing data portions to a second data processing machine at the site designated as a site master; and the first data processing machine receives the missing data portions in a further multicast from the central source and/or a multicast from the second data processing machine at the site. Viewed from another aspect, the invention provides a computer readable medium having computer executable instructions adapted to cause a data processing machine to perform the above method.

Viewed from another aspect, the invention provides a method carried out by a master data processing machine at site where there is a plurality of data processing machines, wherein: data is received by the master data processing machine as a global multicast from a central source remote from the site and is stored in a cache by the master data processing machine; the master data processing machine receives reports of missing data portions from other data processing machines at the site which have received the global multicast; the master data processing machine transmits to the central source notification of the missing data portions; and the master data processing machine subsequently receives those missing data portions in a further global multicast from the central source. Viewed from another aspect, the invention provides a computer readable medium having computer executable instructions adapted to cause a data processing machine to perform the above method.

Viewed from another aspect, the invention provides a method carried out by a master data processing machine at site where there is a plurality of data processing machines, wherein: data is received by the master data processing machine as a global multicast from a central source remote from the site and is stored in a cache by the master data processing machine; the master data processing machine receives reports of missing data portions from other data processing machines at the site which have received the global multicast; the master data processing machine identifies any of the missing data portions in the cache; the master data processing machine transmits any identified missing data portions in the cache by a local multicast to other data processing machines at the site; in the event that any missing data portions are not in the cache, the master data processing machine transmits to the central source notification of those missing data portions; and the master data processing machine subsequently receives those missing data portions in a further global multicast from the central source. Viewed from another aspect, the invention provides a computer readable medium having computer executable instructions adapted to cause a data processing machine to perform the above method.

Viewed from another aspect, the invention provides a method carried out by a central server for distributing data to a plurality of data processing machines at a remote site, wherein: the server transmits the data as a global multicast to the data processing machines at the site; the server receives from a master data processing machine at the site, a notification of missing data portions reported to the master data processing machine by other machines at the site; and the server subsequently transmits those missing data portions to the data processing machines at the site in a further global multicast. Viewed from another aspect, the invention provides a computer readable medium having computer executable instructions adapted to cause a server to perform the above method.

Further features and advantages of the invention will become apparent from the following description of some embodiments of the inventions, given by way of example only, which is made with reference to the accompanying drawing.

### BRIEF DESCRIPTION OF THE DRAWING

FIG. 1 is a diagrammatic overview of a system in accordance with the invention.

### DESCRIPTION OF THE EMBODIMENTS

### Components

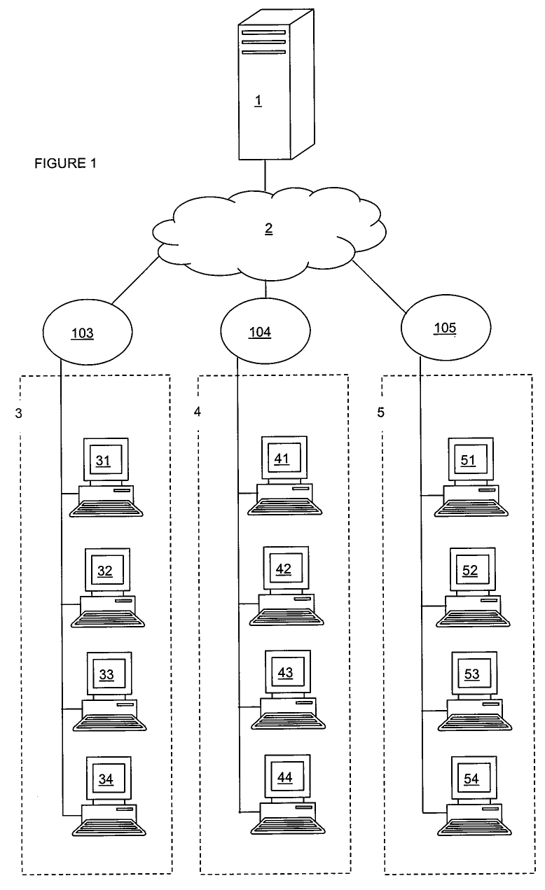

FIG. 1 shows a Microsoftm SMS™ (Systems Management Server) server 1 connected to a wide area network 2 for delivering software packages such as system updates to a number of remote sites 3, 4 and 5, respectively having a number of local client computers 31, 32, 33 34; 41, 42, 43, 44; and 51, 52, 53, 54, via routers 103, 104, and 105. The server 1 need not be a single physical server. Its functions may be provided by a number of physical servers. Any server may be entirely physical or may be a virtual server defined by suitable Virtual Machine software. There may be any number of remote sites and any number of client machines at each site. It is not necessary to have a server at a remote site in order to handle software updates. The local client machines run SMS client software.

The server and the client machines may comprise a microprocessor, volatile memory such as random access memory (RAM), non volatile memory, and bulk data storage such as a hard disk drive. There will be an output device such as a monitor, and one or more input devices such as a keyboard and mouse, track ball or the like. There will be interfaces for connection to a network, connection to peripheral devices such as external storage, printers and so forth for providing printed output, and for example audio input and/or output. Data processing equipment of this type is widely known and available and does not need further discussion here.

Software used to configure the server and the client machines may be provided on a physical data carrier such as a CD or DVD, or may be downloaded over a network such as a LAN or WAN or the Internet.

### Overview of the Embodiments

In one embodiment of the invention, using for example the Nomad Branch™ system, a central multicast advertisement is created and issued ahead of the time scheduled for the multicast. When a machine performs a policy refresh at the usual interval, the advertisement will be seen and the machine is joined to the multicast group in anticipation of the multicast starting. When the multicast starts, each active machine will receive data in the normal way and put it in a cache.

If for any reason a data processing machine at a site misses any of the multicast stream, either due to network congestion or having initiated receipt of the multicast stream after the start of the stream, or for any other reason, the data processing machine will broadcast to the other machines at the site a request for the election of a site master for this multicast package.

If a site master already exists the master will reply to the election request directly informing the data processing machine with the missing data of the master's existence. The data processing machine with the missing data will now send a request for the missing data to be re-sent to the master, which will in turn collate that request with others in the branch and send them on to the source for re-transmission in the multicast stream.

If there is no master already in existence when the master election request occurs then an election is held within the site and the data processing machine with the highest percentage of package data will be chosen as the site master. If multiple data processing machines have the same percentage of the package available then one of the machines will be chosen using either a random selection process or using predetermined criteria. Such criteria could be arbitrary, to the extent that issues such as the relative performances of the machines, hardware or software factors and so forth are not taken into account. For example, the selection could be based on the names of the machines, using alpha/numeric ranking, or the value of their IP addresses, with either the highest or lowest value being selected. Alternatively, the selection could be based on factors such as available disk space or other hardware resources.

Once a master has been elected then all other data processing machines in the same site will use that master. If the existing master should be turned off or be unavailable for any other reason, then at the next request for a fill-in the master will not respond. After retrying the request the machine that cannot get a response for the fill-in request will initiate another master election.

Thus, the system is resilient and if a machine elected as site master fails or is disconnected, another machine at the site will take on the task. This arrangement can cope with multiple failures, with a replacement site master being elected each time. This could be particularly significant in the case of a central multicast that could take place over an extended period, during which a machine may be switched off, replaced for routine maintenance and so forth.

In an alternative arrangement, election of a site master is performed differently. Once a machine has received a predetermined amount of the package multicast, that machine is eligible to act as site master for that machine's site. The predetermined amount could, for example be in the range of about 10% to about 30% and could be about 10%, 15%, 20%, 25% or 30%. When the predetermined amount of the package has been received, the machine listens for master packets from any other machines at its site, for a predetermined length of time. A master packet identifies a machine and the number of package packets that have been received by that machine and are stored in its cache. If the machine receives a master packet from another machine, it checks the packet count to determine which of the machines has the higher package packet count. If the machine has the higher packet count, or if no other master packets have been received, then that machine elects itself as site master and will send a local multicast message containing a master packet to the other machines at its site, which then recognises the new machine as site master.

If a number of machines at a site all receive the package at the same rate, then they would all receive the predetermined amount at the same time and clashes would arise as they all try to elect themselves as site master. In some ebodiments, therefore, there is a random delay before a machine elects itself as site master but during that delay period the machine still listens for master packets from other machines. The machine whose random delay is the shortest will elect itself as site master before any of the others and will start multicasting master packets. The other machines which are still in their delay period will receive the packets and will not then elect themselves as site master.

The site master continues to multicast master packets at predetermined intervals which could for example be in the range of about 15 seconds to about 2 minutes, for example about 15 seconds, about 30 second, or about 45 seconds, and in some embodiments may be about 1 minute. If at any time another machine finds that it has a local package packet count which is higher than that in the master packer multicast by the site master, then it elect itself site master and will start multicasting its own master packets to all other machines at the site. The original site master will then receive a master packet from the other machine, will stop considering itself as the site master and will treat the other machine as the site master. This process is carried out continuously across the site. Any machine that receives a master packet with a package packet count that is lower than the package packet count in the machine's cache, will elect itself as site master and will start to multicast master packets. Any machine that has elected itself site master, and then receives a master packet from another machine, will cease to be site master.

As noted above, the election process depends on whether a machine receiving a master packet has a local package packet count that is higher than that in the received master packet. In some embodiments, the difference in the two counts must exceed a predetermined threshold, which could for example be in the range of about 0.5% to about 2%, and in one particular embodiment is about 1%.

To provide resilience in the case that a site master fails, is switched off, is disconnected from the site LAN (Local Area Network) and so forth, the other machines which are listening for master packets will instigate a replacement master routine if no master packets are determined for a predetermined period of time. That predetermined period could be any period greater than the predetermined intervals at which the site master sends out master packets. In some embodiments however, the arrangement is such that the replacement master routine is not instigated every time that a master packet does not reach a machine, something that could be caused by a factor other than a failure requiring a replacement master to be elected. In some embodiments, therefore, the replacement master routine is instigated if a machine has not received a master packet for a period exceeding an integer multiple of the predetermined interval for master packets to be sent out, for example a multiple of between 2 and 5, and in one particular embodiment this could be 3 or 4. Once the replacement master routine is instigated, the machine elects itself as site master and multicasts its own master packets which are recognised by other machines at the same site. If a number of machines at a site all detect a lack of mater packets at the same time, then clashes would arise as they all try to elect themselves as site master. In some embodiments, therefore, there is a random delay before a machine elects itself as site master but during that delay period the machine still listens for master packets from other machines. The machine whose random delay is the shortest will elect itself as site master before any of the others and will start multicasting master packets. The other machines which are still in their delay period will receive the packets and will not then elect themselves as site master.

Once the central multicast has terminated, which may for example be determined by a predetermined length of time having elapsed without multicast packets being received, each machine checks whether it has the entire package. If packets are missing, the machine sends a fill-in request to the site master, listing the missing packets. In some embodiments, the site master does not ACK such requests. In some embodiments, there is a random delay before the fill-in request is sent by a machine, to prevent all machines sending their requests simultaneously to the site master. The random delay may be calculated by an algorithm which is such that machines with most missing data should get to send their fill-in requests first. This can be achieved by the algorithm taking into account the proportion of missing packets. For example, there could be a number of ranges of missing packet proportions, such as 0-0.9%, 1%-1.9%, 2%-2.9%, and 3% or more, with corresponding ranges of possible delays which are shorter the larger the proportion of missing packets. For example, a machine with a missing packet proportion in the largest range would have a delay selected randomly with a value in the lowest range of delays, for example from 5 seconds to 30 seconds, whereas a machine with a missing packet proportion in the smallest range would have a delay selected randomly with a value in the highest range of delays, for example from 5 minutes to 10 minutes.

The site master will receive the requests from the individual machines and will compare them with the packets that it holds locally in its own cache. If any requested packets are held locally, then it will commence a site multicast of the missing data. Missing packets that are not held locally are collated for a request to be made to the central multicast source. In some embodiments, the site master deals with requests immediately they come in and immediately multicasts the missing packets held in its store. In one such arrangement, each machine which is currently in a stand off period waiting to transmit its request for missing packets to the site master, on receipt of the new multicast packets will terminate the fill-in request procedure and will resume capturing the multicast stream, filling in any missing packets that it finds in the new stream. When the multicast traffic stops again, which may be determined as when a predetermined time has elapsed without any multicast packets being received, the local machine carries out a recalculation again prepares to send a fill-in request for missing packets to the site master after a delay calculated as explained above. The process is repeated as many times as necessary until the site master receives no further requests for missing packets—for example if a predetermined time has elapsed without a missing packet request being received—and there is no further local multicast traffic.

In a modification of this arrangement, the site master will collate requests that are received within a predetermined time interval, for example the time interval set for the delay in which machines with the highest proportion of missing packets will issue their fill-in requests. In the example given above, this would correspond to the period of about 5 to 30 seconds during which requests are sent by machines having a missing packet proportion of 3% or more. The site master will then multicast packets in its local cache that are covered by the collated requests, and the above procedure will then be repeated. Machines will receive the new packets, and then recalculate whether there are any missing packets, so that the fill in request procedure can be repeated. A corresponding process might be carried out for the other ranges of time intervals. Alternatively, after the first local multicast has commenced, all other requests may be collated so that there is a single additional multicast to cover all outstanding requests.

In a further modification, the site master may collate all requests first, thus waiting for a period exceeding the maximum delay for a request to be sent, corresponding to the smallest proportions of missing packets. The multicast of missing packets in the site master's cache will then be carried out and the general fill-in procedures repeated.

At some point, the site master determines what missing packets are not held in its local cache and transmits a request—such as a unicast UDP (User Datagram Protocol) request—to the central multicast server. This could be, for example, after receipt of the first request for missing packets, which would be from a machine having a high proportion of missing packets; or after receipt of requests that are received within a predetermined time interval, for example corresponding to the receipt of requests that have been transmitted in the time interval set for the delay in which machines with the highest proportion of missing packets will issue their fill-in requests; or after the site master has assumed that no further requests are going to be received. The site master will continue to issue its local multicast of missing packets and to handle further requests for missing packets.

In issuing its request for missing packets to the central multicast server, in some embodiments there is a random delay before the fill-in request is sent by the site master, to prevent all site masters across the various sites sending their requests simultaneously to the central multicast server. The random delay may be calculated by an algorithm which is such that site masters with most missing data should get to send their fill-in requests first. This can be achieved by the algorithm taking into account the proportion of missing packets. For example, there could be a number of ranges of missing packet proportions, such as about 0-0.9%, 1%-1.9%, 2%-2.9%, and 3% or more, with corresponding ranges of possible delays which are shorter the larger the proportion of missing packets. For example, a site master with a missing packet proportion in the largest range would have a delay selected randomly with a value in the lowest range of delays, for example from about 5 seconds to 30 seconds, whereas a machine with a missing packet proportion in the smallest range would have a delay selected randomly with a value in the highest range of delays, for example from about 5 minutes to 10 minutes.

The central multicast server will receive the requests from the individual site masters and will commence a global multicast of the missing data to all machines at all sites. In one possible arrangement, the central multicast server will deal with requests immediately they come in. In some such arrangements, each site master which is currently in a stand off period waiting to transmit its request for missing packets to the central multicast server, on receipt of the new multicast packets will terminate the fill-in request procedure, and local machines will terminate their local fill-in requests to their site masters. Site masters will not issue any further requests to the central multicast server until the multicast of the missing data has terminated. When the multicast traffic stops again, the local machines at each site will calculate whether they have missing packets, and there will be a repeat of the procedure for the local machines sending fill-in request for missing packets to the site master, the sit master issuing a local multicast of data in its local cache, and the site master sending a request for packets to the central multicast server.

In a modification of this arrangement, the central multicast server will collate requests that are received within a predetermined time interval, for example the time interval set for the delay in which site masters with the highest proportion of missing packets will issue their fill-in requests. In the example given above, this would correspond to the period of 5 to 30 seconds during which requests are sent by site masters having a missing packet proportion of 3% or more. The above global multicast procedure for missing data will then be carried out. A corresponding process might be carried out for the other ranges of time intervals. Alternatively, after the first global multicast of missing packets has commenced, all other requests from site masters may be collated so that there is a single additional global multicast to cover all outstanding requests.

In a further modification, the central multicast server may collate all requests first, thus waiting for a period exceeding the maximum delay for a request to be sent from a site master, corresponding to the smallest proportions of missing packets. The global multicast of missing packets will then be carried out and the general fill-in procedures repeated.

The various possible methods for implementing the invention may be combined in various ways. For example, at a particular site a site master may start the local multicast of missing packets from its local cache immediately on receipt of a first request for fill-in packets from a local machine—which will be from a machine with one of the highest number of missing packets—but collate all subsequent requests. Similarly, the central multicast server could start the global multicast of missing packets immediately on receipt of a first request for fill-in packets from a site master—which will be from a site with one of the highest number of missing packets—but collate all subsequent requests.

Whichever particular methods, or combinations of methods, are chosen for a particular implementation of the invention, the process is carried out until all machines on all sites have received the complete package that was in the original global multicast.

If a machine joins a multicast stream late, for example because it was offline when the multicast stream started, it will immediately start caching the multicast data from the point at which it joined. In some arrangements that machine does not make a request to the site master for missing data until the multicast transmission stops.

In a some embodiments, the arrangement is such that when a local machine, that is not a site master, has received the entire package successfully, it leaves the multicast group and, for example, signals via an SMS status message against the advertisement ID that it has completed.

Similarly, when a site master has the complete package in its cache and has not received any requests for fill-ins from its local machines for more than a predetermined period, which could for example be about 1 minute, it will leave the multicast group. This will allow the router to drop out of the group and free up bandwidth if other branches are still filling in parts of the package.

It will thus be seen that there is an effective system for ensuring that all machines at all sites end up with the full package, whilst taking advantage of multicast technology from the central server.

In embodiments of the invention, the multicast activity does not interfere with unicast delivery of higher priority packets. Multicast delivery of large packages over slow links may tale a long time, and there may be more urgent day to day data that needs to be delivered, for example using the Nomad™ system referred to earlier.

Some embodiments of the invention permit the central multicast server to send multiple multicast streams to different multicast groups simultaneously.

By way of example, an implementation of the invention may permit a multicast stream of a package to be delivered to 20,000 sites located worldwide, with an average of 10 machines per site, or for the distribution of the package to be via for example 20 simultaneous multicast streams, from a single server.

### Specific Implementation of an Embodiment

In a specific implementation of an embodiment of the invention, using the data processing system of FIG. 1, central multicast advertisements are created ahead of the time that execution is scheduled, with enough time allowed for the clients to receive the policy refresh and receive the full package before execution. Creation of a central multicast advertisement may be performed, for example, by a wizard instigated from a right click context menu whilst focused on a collection.

In order to make an informed calculation about the best transmission rate for the advertisement, it is necessary to have information from each machine in the collection, or at least each subnet, on the available multicast bandwidth from the central server 1. This is achieved by sending a test package to the collection membership and measuring the bandwidth available. The wizard will check to see if all of the members of the collection have this data available, and if they do not it will inform the administrator that a bandwidth availability test job needs to be run before the advertisement can be set up and will then proceed to create a test job advertisement instead. The test job will be scheduled immediately, but it will actually start after a client policy refresh interval has elapsed.

The clients will be sent, via central multicast, a series of short bursts of data at increasing data rates. Each burst should last no longer than a second and there should be several seconds between them, so as to prevent the test job from breaking the network for any more than a second at most. The clients will measure how many packets they received from each burst and send back the results in SMS Status messages. The administrator then attempts to create the multicast advertisement again after the test job has completed. Since the collection members now have multicast throughput data, the wizard allows the administrator to pick advertisement options as normal before moving on to the central multicast setup page. The wizard will analyze the data from the collection members and find the burst speed of the set of packets that successfully arrived at every subnet. This will then form the basis for the multicast network throughput figure for the multicast job.

The wizard then checks that the data rate chosen will allow the entire package to be delivered before the execution time, with an allowance made for additional time to permit fill-in requests for missing data to be fulfilled. If the data rate is too low to allow the package to be delivered in time then the data rate should be raised to a level that will allow the package to be delivered in time, and the administrator is informed of the number of clients that would not receive the package due to being on the end of a slow link, for example. The administrator then has the choice of delaying the execution time to allow the package to be delivered at the lower data rate or to create two advertisements to two sub-collections—a multicast job to the machines that can receive at the higher rate and a unicast job for the rest.

When the advertisement is created an additional flag using the ISVData attribute is set which marks the advertisement as a central multicast one. When a client receives the advertisement in its policy refresh it will know to prepare for a central multicast job.

Right clicking on a central multicast enabled advertisement will expose a context menu item to initiate the multicast stream. This option should preferably not be available until after the maximum client policy refresh interval has elapsed since the advertisement was created. This gives all clients in the collection long enough to have refreshed their policy and started listening to the multicast group before transmission commences.

When the SMS client on a local machine performs its policy refresh and therefore gets a newly created advertisement the a local service sees the central multicast flag on the advertisement and joins the client to the multicast group in anticipation of the multicast transmission starting. When the multicast job starts the client machine receives data in the normal way and places it into a cache. The client machine may, for example, use the SMS Nomad Branch™ system, to which has been added multicast functionality.

If a client joins the multicast stream late it will immediately start caching the multicast data from the point at which it joined. All requests for missing data wait until the multicast transmission stops. When the main multicast transmission has completed, if a client does not have the entire package it will send a fill-in request to a site master listing the missing packets, if it knows the identity of the site master. If the client machine does not know the identity of the site master, the client machine will broadcast to the other machines at the site a request for the election of a site master for this multicast package.

If a site master already exists the master will reply to the election request directly informing the data processing machine with the missing data of the master's existence. The data processing machine with the missing data will now send a request for the missing data to be re-sent to the master, which will in turn collate that request with others in the branch and send them on to the source for re-transmission in the multicast stream.

If there is no master already in existence when the master election request occurs then an election is held within the site and the data processing machine with the highest percentage of package data will be chosen as the site master. By way of example, when a site master election process is initiated, each active machine at that site could broadcast election packets which give their IP address and data representative of the amount of package data received by the machine. If a machine receives an election packet which indicates that another machine has a greater amount of package data, then it drops out of the election process and waits. If after a predetermined time, sufficient for all active machines to have broadcast election packets, if any machine has not received an election packet indicating the same amount of package data that it has, or a greater amount, then it elects itself site master. If it receives one or more packets indicating the same amount of package data as it has received, then it checks the originating machine IP addresses in those packets. If there is any IP address lower than its own IP address, then it drops out of the election process. Thus there will be left a machine which either had the greatest amount of package data at the time the election was called, or has a lower IP address than any other machine which had the same amount of package data at that time.

The machine electing itself site master then broadcasts master packets to the other machines at the site, indicating that it is the master. Any machines with missing data will then send to the site master a request for the missing data to be re-sent. The master will not ACK (acknowledge) these requests. There is a random back-off for these requests. Clients missing most data will get to send their requests first, so the algorithm for the request back-off takes into account the proportion of missing packets in its calculation. If multicast traffic resumes during the back-off period the client will resume capturing the multicast stream and fill in any missing packets it finds in it, and when the multicast traffic stops again re-calculate the back-off and fill-in request.

If the master receives multiple fill-in requests, it collates the requested fill-in packet lists and compares them to the data it holds locally in its own cache. It will immediately start to multicast locally any data it has in its local cache. At the same time it sends a (unicast UDP) request containing a list of packets for the data it does not have in its local cache to the central multicast server 1 using, for example, the same back-off algorithm used locally amongst machines, so that branches missing the most data will send their requests first.

When multicast traffic resumes from the central server 1 the master continues to send its own local multicast data, since local bandwidth utilization should not be an issue, but will not send any more requests for missing local data until the multicast stream from the central server 1 stops again, at which point it re-collates the missing local data and sends another request to the central server.

Eventually all data will be received by all clients. Once a client has successfully received the package, and assuming that it is not the site master, it leaves the multicast group and signals via an SMS status message against the advertisement ID that it has completed the download.

When the site master has received the entire package and has not received any requests for fill-ins for more than a specified period, such as one minute, it also leaves the multicast group. This will allow that site's router to drop out of the group and free up bandwidth if other branches are still filling in parts of the package.

If the master sends requests for missing data to the server but multicast data doesn't resume it will retry a predetermined number of times, such as ten, with increasing back-off intervals. Once the tenth attempt has failed the master gives up and sends a failure status message for the advertisement ID.

If a local client at a site has sent a request for missing data to its site master but there is no multicast traffic forthcoming, it will repeat the request a predetermined number of times, such as five, with increasing back-off intervals. Once the fifth retry has timed out the client will give up and send a failure status message for the advertisement ID.

If the advertisement mandatory assignment becomes active and the multicast job is still in progress then the job should fail gracefully and send back the relevant status message.

If the package source changes the central server 1 will stop sending that specific file, signal a new file in the data stream and start sending the updated file which will overwrite the previous one in the cache.

The central multicast server component runs as a service. It does not have to run on any particular SMS site server, but it must obviously have access to the DP to obtain the package data. The server component has an understanding of SMS advertisements and recognizes those marked as central multicast adverts. It will start multicasting to a group specific to each advert when instructed to do so by an administrator using the transmission rate specified in the advertisement creation wizard. It will not listen for any return traffic from the clients until the entire original package has been sent.

Once the whole package has been sent it will listen for requests from branch masters. If it receives multiple requests it will collate them and start to send the requested missing information immediately. At the same time it will continue to listen for new requests and collate them into the list of data to be sent.

The service will stop listening for requests for the package at the time the package becomes mandatory (i.e. execution time) since at this point any clients that have not finished the multicast stream will have failed anyway.

In a particular implementation of this embodiment of the invention, the following reports will be provided.
Multicast Bandwidth Report. Using the data reported back by the test jobs the report outlines the multicast bandwidth speed for each subnet.
Package Success Report. This report lists for all multicast advertisements, the total number of clients in the collection, the total number of clients that reported success, the total number of clients that reported failure, and totals for each failure type, and the number of machines that did not report at all
Which Machines Had Errors Of Which Type Report. This is a report for a particular multicast advertisement which lists each client name grouped into different failure types
How Far Through The Initial Multicast Is The Job Report. This is a report listing all active multicast jobs, how far through the initial transmission they are (in terms of percentage), how much data has been sent, how much data the package has in total, the transmission speed, the estimated time to completion (delta) and the estimated time of completion (absolute)

How Efficient Was The Distribution Report. For completed multicast distributions how much data was in the package, how much data was re-sent in response to requests, and the total percentage of data sent (100%+). It will be appreciated that the invention is not limited to the particular embodiments described and that many design changes may be made within the principles of the invention. Those skilled in the art will realize that such changes or modifications of the invention or combinations of elements, variations, equivalents or improvements therein are within the scope of the various broad aspects of the invention disclosed in this specification, and in particular are within the scope of the invention as defined in the appended claims.

What is claimed is:

1. A data processing system comprising a central data processing data source and a plurality of remote data processing machines arranged in a plurality of sites, there being a plurality of said data processing machines at each said site, wherein:
the central data processing data source is configured to transmit data from the source to the plurality of remote data processing machines by multicasting;
at each said site:
one of the plurality of data processing machines at the site is configured to be designated as a site master;
the remainder of the plurality of data processing machines at the site are configured to report missing data portions to the site master; and
the site master is configured to consolidate reports of missing data portions, and to request missing data portions from the central data processing source;
and wherein the central data processing source is configured to process requests for missing data portions from the site master at each said site, and to multicast the missing data portions to the plurality of remote data processing machines.

2. A data processing system as claimed in claim 1, wherein the site master at a site is configured such that if the site master receives a report of missing data that the site master has stored locally, the site master provides that missing data to the local machines by means of a site multicast.

3. A data processing system as claimed in claim 1, wherein the central data processing source is configured to consolidate reports of missing data received by the source from site masters at different sites, before the source transmits the missing data to the plurality of sites by means of the further multicast.

4. A data processing system as claimed in claim 1, wherein at each said site the data processing machines are configured such that:
if a first data processing machine at a site is missing data from the multicast from the source, and is not aware that a site master has been designated for the site, that data processing machine broadcasts, to the remaining plurality of machines at the site, information indicating that a site master is required; and either
(i) if a second data processing machine at the site is already designated as site master, the second data processing machine notifies the first data processing machine that the second data processing machine is the site master; or
(ii) if none of the remaining plurality of machines at the site is already designated as site master, an election process is instigated to designate one of the plurality of machines at that site as site master.

5. A data processing system as claimed in claim 4, wherein at each said site the machines are configured such that the election process results in designation of a machine which has received the greatest amount of the multicast at the time that the election is instigated.

6. A data processing system as claimed in claim 5, wherein at each said site the machines are configured such that if more than one machine has received the greatest amount of the multicast at the time that the election is instigated, at least one predetermined criteria is used to choose one of said more than one machines as the site master.

7. A data processing system as claimed in claim 6, wherein at each said site the machines are configured such that the choice of one of said more than one machines as the site master is made on the basis of the IP addresses of said more than one machines.

8. A data processing system as claimed in claim 1, wherein at each said site the machines are configured such that if a first machine at a site believes that a second machine at the site is the site master but receives no response after sending a report of a missing data portion to said second machine, the first machine broadcasts to the remaining plurality of machines at the site information indicating that a site master is required.

9. A data processing system as claimed in claim 1, wherein at each said site the machines are configured such that once the multicasting of data from the source has terminated, each machine checks whether it has all of the data transmitted by the source.

10. A data processing system as claimed in claim 9, wherein at each said site the machines are configured such that each machine waits for a delay before reporting missing data portions to the site master.

11. A data processing system as claimed in claim 10, wherein at each said site the machines are configured such that each machine calculates the delay by an algorithm which is such that machines at the site with most missing data, report missing data portions first.

12. A data processing system as claimed in claim 1, wherein at each said site the site master is configured to wait for a delay before requesting missing data portions from the source.

13. A data processing system as claimed in claim 12, wherein at each said site the site master is configured so that the delay is calculated by an algorithm which is such that site masters with most missing data portions to request, request those missing data portions first.

14. A data processing system as claimed in claim 1, wherein at each said site the site master is configured so that once the site master receives packets in the further multicast from the source, the site master does not issue a request for missing data portions to the source until the further multicast has finished.

15. A data processing system as claimed in claim 1, wherein at each said site the machines are configured such that once a machine that is not a site master receives packets in the further multicast from the source, that machine does not report missing data portions to the site master until the further multicast has finished.

16. A data processing system as claimed in claim 1, wherein at each said site the machines are configured such that each machine can act:
(i) in a first manner as said site master which receives reports of missing data portions from the remainder of the plurality of local machines at the site, consolidates the reports of missing data portions, and requests missing data portions from the central data processing source; and
(ii) in a second alternate manner as one of the remainder of the plurality of data processing machines which reports missing data portions to the site master;
and such that the machine can switch between said first and second manners.

17. A data processing system comprising a plurality of data processing machines at a site, wherein at said site:
the data processing machines are each configured to receive data as a multicast from a central source remote from the site;
one of the data processing machines is designated as a site master;
the remaining data processing machines are configured to report missing data portions to the site master; and
the site master is configured to consolidate reports of missing data portions, and to request missing data portions from the central source;
and wherein the data processing machines are configured to receive missing data portions in a further multicast from the central source.

18. A data processing system as claimed in claim 17, wherein at said site the data processing machines are configured such that each machine can act both:
(i) in a first state as said site master which receives reports of missing data portions from the remainder of the plurality of data processing machines at the site, consolidates the reports of missing data portions, and requests missing data portions from the central data processing source; and
(ii) in a second, alternate state as one of the remainder of the plurality of data processing machines which reports missing data portions to the site master;
and such that each machine can change between the fist state and the second, alternate state.

19. A data processing machine at site where there is a plurality of data processing machines, wherein said data processing machine is configured to be capable of adopting a first operational state and a second, alternate operational state, and to choose between the first and second operational states, wherein:
(i) in the first operational state said data processing machine is configured to receive data as a multicast from a central source remote from the site; to report missing data portions to another data processing machine at the site designated as a site master; and to receive missing data portions in a further multicast; and
(ii) in the second operational state the first data processing machine is configured to act as a site master which:
(a) receives data as a multicast from a central source remote from the site; and
(b) receives reports of missing data portions from the remainder of the plurality of data processing machines at the site, consolidates the reports of missing data portions, and requests missing data portions from the central source.

20. A data processing machine as claimed in claim 19, wherein when the data processing machine is in the first operational state it is configured to receive missing data portions in a further multicast from the central source and from the site master.

21. A data processing machine as claimed in claim 20, wherein when the data processing machine is in the second operational state it is configured:
(i) to store in a cache the data in the multicast from the central source;
(ii) in response to a report of a missing data portion from another of the data processing machines at the site, to identify whether the missing data portion is in the cache;
(iii) if the missing data portion is in the cache, to transmit the missing data portion in the cache to other data processing machines at the site by a local multicast; and
(iv) if the missing data portion is not in the cache, to request the missing data portions from the central source.

22. A computer readable medium having computer executable instructions adapted to cause a data processing machine to be configured so that:
said data processing machine can adopt a first operational state and a second operational state, and can elect between the first and second operational states, wherein:
(i) in the first operational state said data processing machine is configured to receive data as a multicast from a central source remote from the site; to report missing data portions to another data processing machine at the site designated as a site master; and to receive missing data portions in a further multicast; and
(ii) in the second operational state the first data processing machine is configured to act as a site master which:
(a) receives data as a multicast from a central source remote from the site; and
(b) receives reports of missing data portions from the remainder of the plurality of data processing machines at the site, consolidates the reports of missing data portions, and requests missing data portions from the central source.

23. A computer readable medium as claimed in claim 22, wherein the instructions are adapted to cause the data processing machine to be configured so that when the data processing machine is in the first operational state it is configured to receive missing data portions in a further multicast from the central source and from the site master.

24. A computer readable medium as claimed in claim 23, wherein the instructions are adapted to cause the data processing machine to be configured so that when the data processing machine is in the second operational state it is configured:
(i) to store in a cache the data in the multicast from the central source;
(ii) in response to a report of a missing data portion from another of the data processing machines at the site, to identify whether the missing data portion is in the cache;
(iii) if the missing data portion is in the cache, to transmit the missing data portion in the cache to other data processing machines at the site by a local multicast; and
(iv) if the missing data portion is not in the cache, to request the missing data portions from the central data processing source.

25. A central server configured for distributing data to a plurality of remote data processing machines arranged in a plurality of sites, there being a plurality of said data processing machines at each said site, wherein the server is configured:
(i) to transmit the data as a global multicast to the data processing machines;
(ii) to receive from a master data processing machine at each remote site, a notification of missing data portions reported to the master data processing machine by other of the other machines at the site;
(iii) to consolidate reports of missing data portion received by the source from site masters at different remote sites; and subsequently
(iv) to transmit the missing data to the plurality of remote data processing machines by means of a further global multicast.
